(19) United States
(12) Patent Application Publication
(10) Pub. No.: US 2024/0351515 A1
(43) Pub. Date: Oct. 24, 2024

(54) MULTI-FUNCTION WARNING LIGHT BAR AND VEHICLE SYSTEM STATUS INDICATOR

(71) Applicant: HiViz Lighting, Inc., Hendersonville, NC (US)

(72) Inventors: Samuel T. Massa, Hendersonville, NC (US); Whitaker McRae, Hendersonville, NC (US)

(73) Assignee: HiViz Lighting, Inc., Hendersonville, NC (US)

(21) Appl. No.: 18/639,446

(22) Filed: Apr. 18, 2024

Related U.S. Application Data
(60) Provisional application No. 63/497,153, filed on Apr. 19, 2023.

(51) Int. Cl. B60Q 1/52; B60Q 1/00; B60Q 1/26

(52) U.S. Cl. CPC B60Q 1/52; B60Q 1/0023; B60Q 1/2611

(57) ABSTRACT

A lightbar configured to couple with an emergency vehicle, the lightbar includes one or more warning lights configured to emit an emergency flash pattern, and an indicator light configured to display one or more status indicators of the emergency vehicle. Further, A system configured to display a one or more status indicators of an emergency vehicle, including the lightbar described herein, a plurality of sensors, and a processor, wherein the processor is configured to receive a plurality of signals from the plurality of sensors, and direct the indicator light of the light bar to display the one or more status indicators of an emergency vehicle based on the plurality of signals.

### BACKGROUND

Fire apparatus and other public safety or utility vehicles have many systems on board. These systems include things like water tanks, pumps, engines, hydraulic systems, foam systems, and alerting systems, and more. These vehicles are often equipped with emergency lighting, including a product called a warning lightbar.

Historically, warning lightbars were almost always used to act as a means to clear traffic or alert traffic to the vehicle's presence in the roadway. Their purpose was limited to increasing conspicuity. As technology evolved, some manufacturers began incorporating white LEDs in and including the ability to turn a lightbar from flashing red, to a steadily burning white to help provide work light on the scene as well. These LEDs almost always share a common optic with a primary warning LED of the emergency vehicle.

Firetrucks are equipped with a variety of indicators. A water tank level indicator is placed on both sides of the body and shows the operator and firefighters how much water is left in the tank. An audible buzzer is included in/on/near the cab which alerts to a low-voltage condition on the apparatus. A “do not move truck” light is often installed which indicates when pole lights or towers are deployed. A pump-engaged light is mounted on the pump panel to let the operator know when the apparatus is in pump gear. A horn button is placed on the exterior of the truck which can be pressed 3 times to indicate an emergency evacuation order has been given. Fuel gauges, water pressure gauges, battery voltage or charge status indicators, and a variety of other similar systems are mounted all around the vehicle to indicate to the operators and firefighters what is occurring with the various systems on the truck.

In a structural firefighting response, often times the emergency vehicle is left unattended, or attended by a single person with many functions while the crew is carrying out other critical fireground functions. For the safety of the firefighters who rely on the truck and its water supply, is important that the truck never runs out of water. Before the crews go in the door of a house on fire, it's not uncommon for them to glance back at the truck's water tank level indicator to be sure they have enough water as they go inside the structure, relying on the tank of water being available for their mission.

In some firefighting scenarios, additional emergency vehicles may be used to supply water to a fire. One configuration known as “relay pumping” where additional emergency vehicles connect in series to fill the tank of another emergency vehicle that is pumping the fire. In “Water shuttle” operations, a drop tank is placed and another emergency vehicle (the “relay tanker”) then drives back and forth to a hydrant to refill itself. Sometimes the operator of the water supply operation has to hook the pumping apparatus, engage the pump, and manage multiple trucks at one time. The key function they need to know is when their tank is empty, and when the truck they're filling is full. Similarly, when refilling the tanker at the hydrant, and an operator is by themselves, they must hook the truck up, run over to the hydrant, and open the hydrant to fill the truck. This process can be lengthy, the valve attachment atop of the hydrant must be opened, which often takes numerous turns. Further, the valve must be either all the way closed or all the way open to prevent damaging the truck, to prevent sucking dirt into the vehicle. Accordingly, as the tanker is filling, right before it gets full, the operator must wring the valve back closed very quickly so that the water level doesn't hit the top of the tank and blow water out of the tank. It is also important for the operator not to move too fast though, to avoid water-hammering the lines and causing the water main to break. Both of these scenarios can be incredibly difficult to manage in an emergency situation.

In some applications, especially in rural agencies and in wildland applications, the operator (as a firefighter responding on any given apparatus) deploys a handline, throws the truck in pump gear, charges the line, then run off and to respond to the situation while looking back at the truck until it's empty. When it's empty, the operator then has to run back and disengage the pump to prevent it from burning up.

Accordingly, systems and devices for determining an emergency vehicles water level from large distances, and while filling up at a fire hydrant are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, disclosed herein is a lightbar configured to couple with an emergency vehicle, the lightbar including one or more warning lights configured to emit an emergency flash pattern, and an indicator light configured to display one or more status indicators of the emergency vehicle.

In some embodiments, the one or more warning lights are a first warning light and a second warning light. In some embodiments, the indicator light is disposed between the first warning light and the second warning light.

In some embodiments, the indicator light and the one or more warning lights are combined into a single light source.

In some embodiments, the one or more status indicators of the emergency vehicle include a water level of a water tank of the emergency vehicle, a charge level of the emergency vehicle, a presence of a stop-engine condition of the emergency vehicle, or a combination thereof. In some embodiments, the indicator light is configured to emit a colored light indicative of the one or more status indicators of the emergency vehicle. In some embodiments, the indicator light is configured to emit a percentage light indicative of the one or more status indicators of the emergency vehicle. In some embodiments, the indicator light is configured to emit a flash pattern indicative of the one or more status indicators of the emergency vehicle. In some embodiments, the indicator light is configured to emit a graduated bar graph of light indicative of the one or more status indicators of the emergency vehicle. In some embodiments, the one or more warning lights are configured to emit the emergency flash pattern while the indicator light emits displays one or more status indicators of the emergency vehicle.

In some embodiments, the one or more warning lights are configured to stop emitting the emergency flash pattern while the indicator light emits displays one or more status indicators of the emergency vehicle.

In some embodiments, the emergency vehicle is a firetruck.

In some embodiments, the one or more warning lights and the indicator light are controlled independently. In some embodiments, the one or more warning lights are communicatively coupled to a first circuit, and wherein the indicator light is coupled to a second circuit.

In yet another aspect, disclosed herein is a system configured to display a one or more status indicators of an emergency vehicle, including the lightbar as disclosed herein a plurality of sensors, and a processor, where the processor is configured to receive a plurality of signals from the plurality of sensors, and direct the indicator light of the light bar to display the one or more status indicators of an emergency vehicle based on the plurality of signals.

In some embodiments, the plurality of sensors includes a stop engine sensor and the processor is further configured to receive a signal from the stop engine sensor indicative of a presence of a stop engine condition, and direct the indicator light to emit light indicative of the presence of a stop engine condition.

In some embodiments, the plurality of sensors includes a transducer and the processor is further configured to receive a water level signal from the transducer, wherein the water level signal corresponds to a water level of a water tank of the emergency vehicle, and direct the indicator light to emit light indicative of the water level of the water tank.

In some embodiments, the processor is further configured to receive a voltage signal indicative of a charge level of the emergency vehicle and direct the indicator light to emit light indicative of the charge level of the emergency vehicle.

In some embodiments, the processor is further configured to direct the indicator light to emit light, and direct the one or more warning lights to emit light, wherein the indicator light and the one or more warning lights are directed to emit light simultaneously.

In some embodiments, the processor is further configured to direct the indicator light to emit light and turn off the one or more warning lights.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an example lightbar, in accordance with the present technology;

FIG. 2 is an example system diagram, in accordance with the present technology;

FIG. 3A is an example lightbar emitting an indicator light, in accordance with the present technology;

FIG. 3B is an example light bar emitting a plurality of indicator lights, in accordance with the present technology;

FIG. 3C is an example lightbar emitting another indicator light, in accordance with the present technology;

FIGS. 4A-4D is a process diagram of an example indicator light pattern, in accordance with the present technology;

FIG. 5 is an example lightbar coupled with an emergency vehicle, in accordance with the present technology;

FIG. 6 is an example method of emitting an indicator light, in accordance with the present technology;

FIG. 7 is another example method of emitting an indicator light, in accordance with the present technology; and

FIG. 8 is yet another example method of emitting an indicator light, in accordance with the present technology.

### DETAILED DESCRIPTION

While illustrative embodiments have been illustrated and described, it will be appreciated that various changes can be made therein without departing from the spirit and scope of the invention.

Disclosed herein is a multi-colored circuit communicatively coupled to a lightbar, that is separate from primary traffic clearing LEDs and which are not scene/work lights, which is used as an indicator of functions on the truck. It can be a tank level indicator, a charge status indicator, or it can be a problem indicator for other systems on the apparatus. The lightbar is more visible than any other indicators in conventional emergency vehicles as it is mounted prominently on the roof, and it can be seen multiple operators on the fireground at one time. The light bar is visible from great distances and allows firefighters to quickly glance up to check the status of their emergency vehicle.

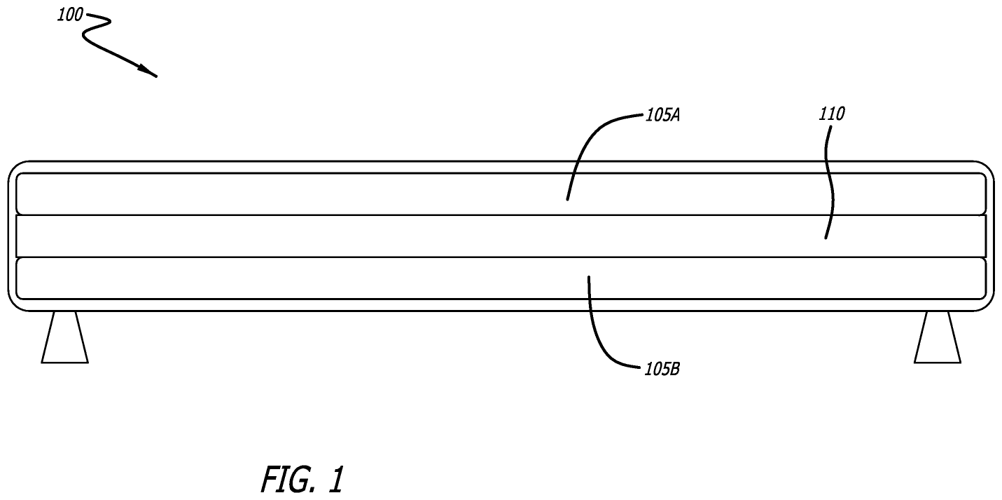

FIG. 1 is an example lightbar 100, in accordance with the present technology. In some embodiments, the lightbar 100 has three rows of light-emitting diodes (LEDs) 105A, 105B, 110. In some embodiments, the three rows (or light sources) include a top row 105A and bottom row 105B that are single color high intensity optics and LEDs. In some embodiments, the lightbar 100 further has a middle row 110 which has red, green, blue, amber, and white LEDs that are independently controlled separate to the primary warning light circuits (the top row 105A and the bottom row 105B).

In some embodiments, the top row 105A and the bottom row 105B are configured to turn on and off together. The top row 105A and the bottom row 105B together are referred to herein as “warning lights.” In some embodiments, the top row 105A and the bottom row 105B are configured to emit light. In some embodiments, top row 105A and the bottom row 105B are configured to emit light in a flashing pattern. In some embodiments, top row 105A and the bottom row 105B are configured to emit white light. In some embodiments, top row 105A and the bottom row 105B are configured to emit red light.

In some embodiments, the middle row (or “indicator light”) 110 is configured to be controlled independently of the top row 105A and the bottom row 105B. In some embodiments, the indicator light 110 is capable of emitting light in any number of colors, including amber, red, white, green, blue, yellow, purple, and the like. In some embodiments, the indicator light 110 is configured to emit light indicative of one or more statuses of an emergency vehicle and/or the lightbar. For example, in some embodiments, the indicator light 110 is configured to indicate a water level of the emergency vehicle, a charge level of the emergency vehicle, a charge level of one or more LEDs of the light bar, a firefighting foam level, a fuel level, a pressure level, a “stop engine” condition of the emergency vehicle, and the like. In some embodiments, the indicator light 110 is configured to emit light either as a continuous light or in a flashing pattern indicative of the one or more statuses of the emergency vehicle and/or lightbar. The indicator light 110 may emit light indicative of the one or more statuses while the warning lights 105A, 105B are on, flashing, and/or off. In some embodiments, the indicator light 110 comprises a red-green-blue (RGB) LED, a single-die multi-color LED, individual single-color LEDs in an array, a chip-on-board (CoB) LED, or a combination thereof. As used herein, the light indicator 110 and the warning lights 105A, 105B may be comprised of any number of LEDs.

In some embodiments, the light bar may not include warning lights 105A, 105B. In such embodiments, the indicator light 110 is configured to both flash (for the purpose of traffic clearing conspicuity) and indicate one or more statuses of an emergency vehicle or the lightbar 100.

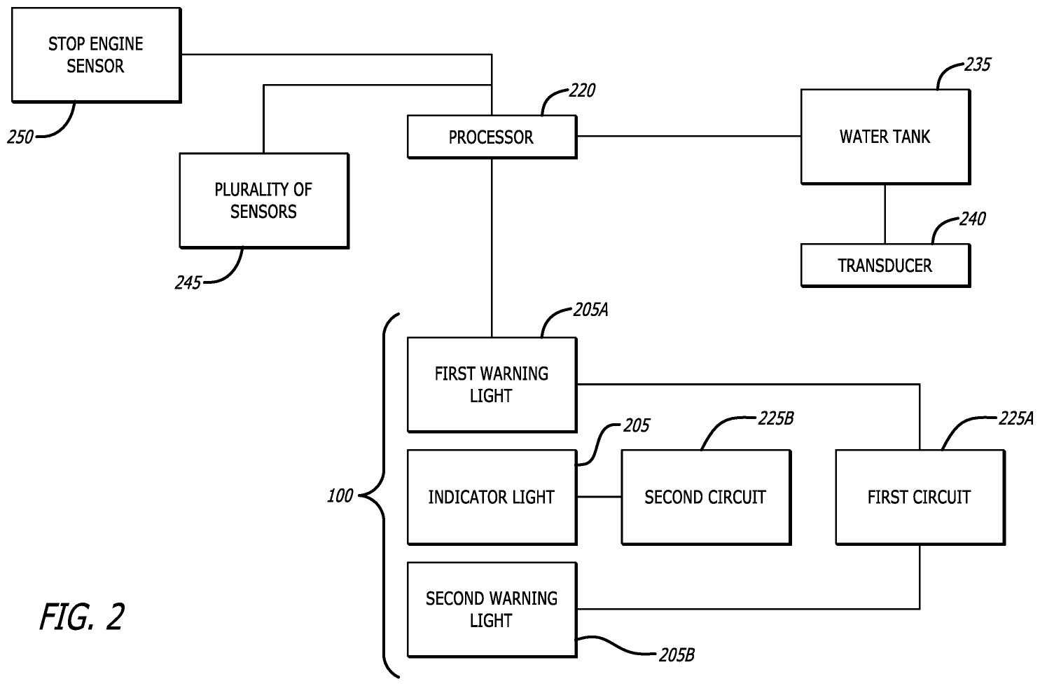

FIG. 2 is an example system diagram, in accordance with the present technology. In some embodiments, the lightbar 100 includes a first warning light 205A (such as top row 105A), a second warning light 205B (such as bottom row 105A), and an indicator light 205 (such as indicator light 105). In some embodiments, the first warning light 205A and the second warning light 205B are communicatively coupled to a first circuit 225A. In some embodiments, the indicator light 205 is communicatively coupled to a second circuit 225B. This allows the warning lights 205A, 205B to be operated independently from the indicator light 105. While two warning lights 205A, 205B are shown, it should be understood that any number of warning lights may be implemented into light bar 100, including one warning light, and no warning lights.

In some embodiments, the lightbar 100 has a means (such as processor 220) to communicate with a plurality of sensors 245. In some embodiments, the processor 220 may be referred to herein as a “microcontroller.” In some embodiments, the plurality of sensors 220 include, but are not limited to, a J1939 CAN port, a Bluetooth chip, a LIN port. In some embodiments, the lightbar 100 is communicatively coupled with specific sensors, such as a stop engine sensor 250, and a water tank transducer 240 coupled to a water tank 235 of the emergency vehicle. In some embodiments, the stop engine sensor 250, and a water tank transducer 240 are included in the plurality of sensors 245. In some embodiments, the plurality of sensors 245 include a grouping of discrete inputs which can be programmed to turn functions on (such as to display indications of a status condition of the emergency vehicle). In some embodiments, the plurality of sensors 245 also includes a sensor configured to detect input voltage and current consumption.

In some embodiments, the processor 220 (or “microcontroller”) is configured to receive signals from the plurality of sensors 245, the stop engine sensor 250, and/or the water tank transducer 240. The processor 220 may then direct the indicator light 205 to emit light corresponding to conditions detected by the plurality of sensors 245, the stop engine sensor 250, and/or the water tank transducer 240.

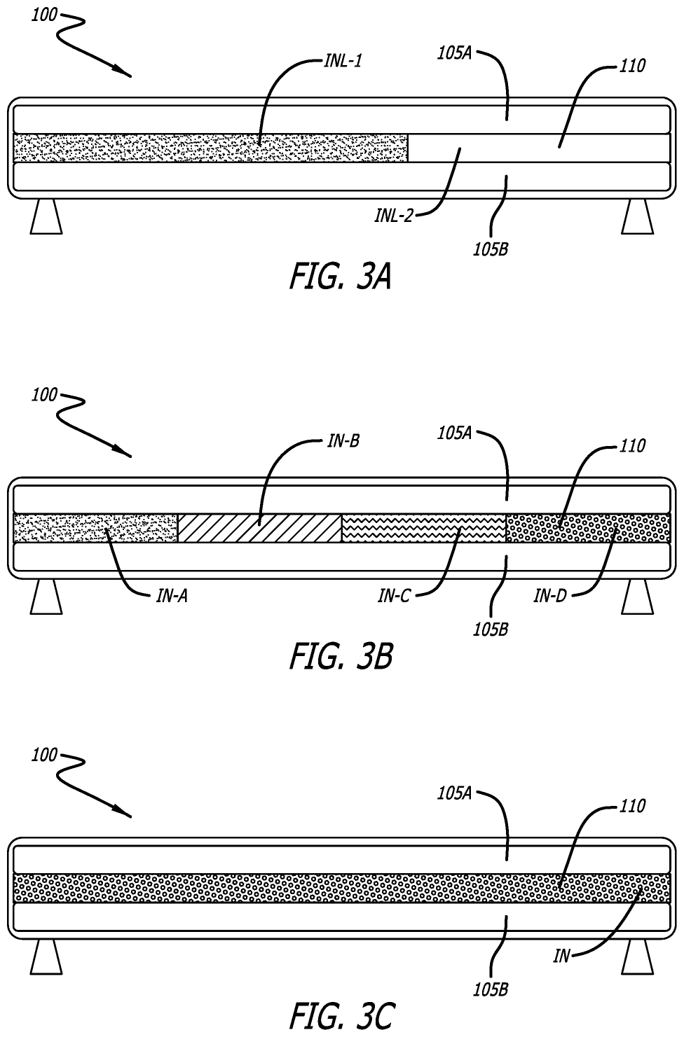

For example, in some embodiments, the emergency vehicle has a water tank 235. In some embodiments, a transducer 240 is communicatively coupled to the water tank 235. In some embodiments, the transducer 240 is configured to sense a water level of the water tank 235. The transducer 240 may transmit a water level to the processor 220, which may then direct the indicator light 205 to emit a light indicative of the water level (such as shown in FIG. 3A). In some embodiments, the indicator light 105 may indicate any status of the emergency vehicle, such as a firefighting foam level, a fuel level, a pressure level, and the like. In some embodiments, the indicator light 105 is configured to display any indicator light that appears on a dashboard of the emergency vehicle, such as battery level, check engine status, firefighting foam level, fuel level, and the like.

In some embodiments, the system 200 further includes a speaker. In some embodiments, the speaker emits an auditory alert along with the indicator light 210. In some embodiments, the auditory alert is a chime, tone, verbal alert (such as “WATER TANK LEVEL LOW”), or the like. In some embodiments, the auditory alert is emitted contemporaneously from light emitted from the indicator light 210, the warning lights 205A, 205B, or both.

FIG. 3A is an example lightbar 100 emitting a light INL-1, INL-2, in accordance with the present technology. In some embodiments, the lightbar 100 includes warning lights 105A, 105B, and an indicator light 110.

In some embodiments, the lightbar 100 indicates a status of the emergency vehicle, such as a water level of the water tank or a charge level of a battery of the emergency vehicle. In some embodiments, the indicator 110 is configured to display a “sliding scale” light to indicate the water or charge level. For example, in some embodiments, the indicator light 110 emits a first light INL-1 indicates a percentage of the full light bar 110 that corresponds with a percentage of available water and/or charge. In some embodiments, the indicator light 110 also emits a second light INL-2 indicating a percentage of used water and/or charge. In some embodiments, the first light INL-1 is a different color than the second light INL-2. In some embodiments, the first light INL-1 is on in a particular color, and the second light INL-2 is actually a region of the indicator light 110 that is turned off. When displaying a water tank level (as explained in FIG. 2), a transducer (such as transducer 240) is installed in the water tank (such as water tank 235). The data from the transducer may be fed to the lightbar 100 over CAN or another analog means.

FIG. 3B is an example lightbar 100 emitting a plurality of lights IN-A, IN-B, IN-C, IN-D, in accordance with the present technology. In some embodiments, the lightbar 100 includes warning lights 105A, 105B, and an indicator light 110.

In some embodiments, the lightbar 100 is configured to emit a plurality of lights IN-A, IN-B, IN-C, IN-D, each indicative of a status of an emergency vehicle or the lightbar 100 itself. In some embodiments, each light IN-A, IN-B, IN-C, IN-D emitted by the indicator light 110 is indicative of a different component of the emergency vehicle or the indicator light. In such embodiments, each light IN-A, IN-B, IN-C, IN-D may be emitted in a different or same color, depending on the status of each component. In other embodiments, each light IN-A, IN-B, IN-C, IN-D, when displayed together, are a graduating bar graph using different colors to indicate multiple functions. For example, IN-A could display a water level, IN-B a charge level, IN-C a presence or absence of a “stop engine” condition, and the like.

In one example, when the lightbar 100 indicates a charge status indicator, the processor or microcontroller (MCU) may be programmed to a minimum and maximum voltage. This function is then displayed with the indicator light 110. The transition from showing warning functions to displaying voltage can be called over CAN, or by activating a discrete input which tells the lightbar to display charge status. The circuits are modular, so the status may be indicated as a graduating bar graph using different colors to indicate functions. For instance, the right-most region (emitting IN-A) could be red, then blue (emitting IN-B), then yellow (emitting IN-C), then green (emitting IN-D). In other embodiments, the whole bar could be red, then yellow, then blue, then green to indicate status.

FIG. 3C is an example lightbar 100 emitting another light IN, in accordance with the present technology. In some embodiments, the indicator light 110 emits a solid or flashing light IN across the entire indicator light 110.

Conventionally, if a firetruck is experiencing a problem, the “stop engine” light may be illuminated on a dashboard of the firetruck. The truck's MCU may turn on a 12v output which turns on an indicator on the dashboard. The same MCU may send a CAN message that instructs the firetruck to stop the engine, and the instrumentation on the dashboard then displays the message. In some embodiments of the present technology, the light bar 100 may be communicatively coupled to the MCU of the firetruck and receive the MCU's 12v output (with a same circuit as the light bulb on the dash) or can interpret the CAN message and display, with the indicator light 110, an indication corresponding with instructions to stop the engine of the firetruck. In operation, if an operator (or responder) is watching the truck, the operator could look out at lineup of firetrucks and see if one or more needed the engine stopped (a “stop engine” condition). In some embodiments, the indicator light 110 may emit a light pattern, such as an amber flash followed by a green flash, followed by the indicator 110 turning off. In this manner, an operator could easily see and detect an issue with the engine of the firetruck and address the issue quickly and efficiently.

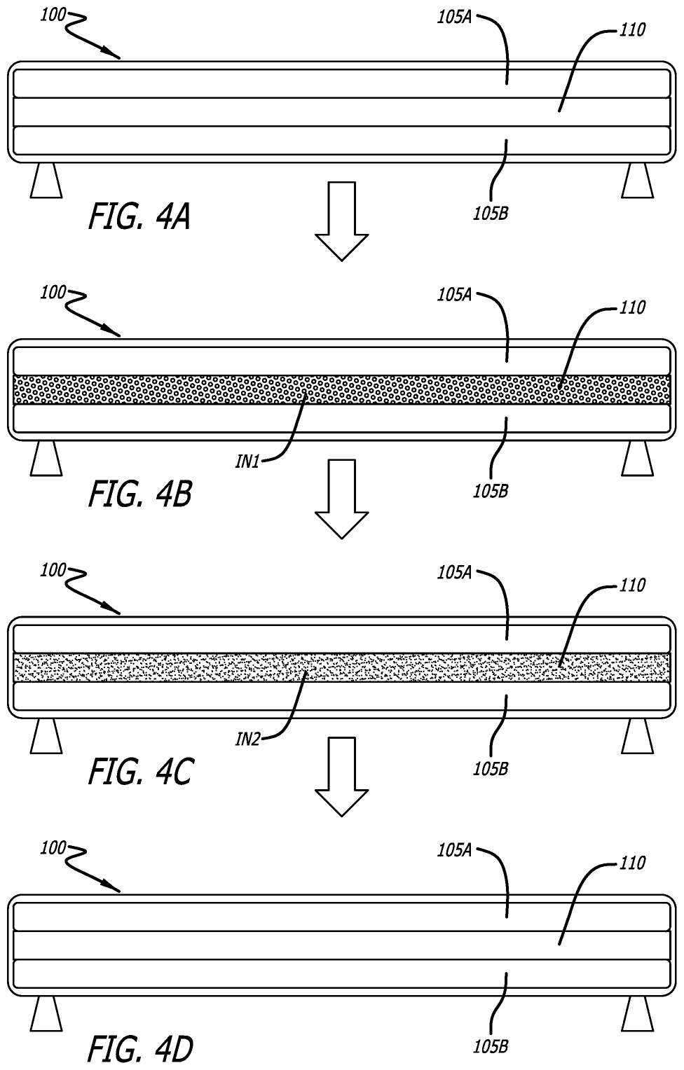

FIGS. 4A-4D are process diagrams of an example indicator light 110 emitting a light pattern IN1, IN2, in accordance with the present technology. In some embodiments, the indicator light 110 is configured to emit a light pattern IN1, 1N2 (or flash pattern) to indicate a status of the one or more statuses of the emergency vehicle and/or light bar. In some embodiments, the flash pattern IN1, IN2 includes emitting light in one or more colors. For example, in FIG. 4B, a first color light IN1 is emitted. In FIG. 4C a second color light IN2 is emitted after the first color light IN1. In this manner, the indicator light 110 may flash multiple colors to indicate a status of the one or more statuses of the emergency vehicle and/or light bar. In some embodiments, each color light IN1, IN2 is emitted for the same time. In other embodiments, each color light IN1, IN2 is emitted for a different amount of time. In some embodiments, any number of flashes/colors IN1, IN2 may be emitted by the indicator light 110. In some embodiments, the same color may be emitted, followed by turning off the indicator light, and then turning the indicator light back on, to flash a same color.

In some embodiments, the indicator light 110 flashes or otherwise emits light indicating a status of the one or more statuses of the emergency vehicle and/or light bar while the warning lights 105A, 105B emit light. In some embodiments, the indicator light 110 flashes or otherwise emits light indicating a status of the one or more statuses of the emergency vehicle and/or light bar while the warning lights 105A, 105B are turned off.

When the warning lights are flashing, the indicator light 110 can emit light showing indicator functions together with the flashing, on top of them in-between flash modes, or without them turned on.

Below is an example of the first warning light 105A (top row), the indicator light 110 (middle row) and the second warning light 105B (bottom row) in an in-line flashing pattern:
Top: <flashing red, pattern 1><flashing red, pattern 1><off-off-off-off-off-off-off><flashing red, pattern 1>
Middle: <flashing red, pattern 1><flashing red, pattern 1><stop-engine indication><flashing red, pattern 1>
Bottom: <flashing red, pattern 1><flashing red, pattern 1><off-off-off-off-off-off-off><flashing red, pattern 1>

In such embodiments, the indicator light 110 may also emit a flashing pattern similar to or identical to the warning lights 105A, 105B, followed by a stop engine indication as explained herein, followed by continuing the flashing pattern of the warning lights 105A, 105B. The warning lights 105A, 105B may turn off while the stop engine indication is displayed.

Below is an example of the first warning light 105A (top row), the indicator light 110 (middle row) and the second warning light 105B (bottom row) in “at the same time” flashing pattern:
Top: <flashing red, pattern 1><flashing red, pattern 1><flashing red, pattern 1><flashing red, pattern 1>
Middle: <stop-engine indication><stop-engine indication><stop-engine indication><stop-engine indication>
Bottom: <flashing red, pattern 1><flashing red, pattern 1><flashing red, pattern 1><flashing red, pattern 1>

In such embodiments, the warning lights 105A, 105B continue flashing while the indicator light 110 repeats the stop engine indication.

Below is an example of the first warning light 105A (top row), the indicator light 110 (middle row) and the second warning light 105B (bottom row) in an “indication without warning functions” mode.
Top: <off-off-off-off-off-off-off><off-off-off-off-off-off-off><off-off-off-off-off-off-off>
Middle: <stop-engine indication><stop-engine indication><stop-engine indication>
Bottom: <off-off-off-off-off-off-off><off-off-off-off-off-off-off><off-off-off-off-off-off-off>

In such embodiments, the warning lights 105A, 105B may be turned off while the indicator light 110 emits light corresponding to an indication of one or more statuses of the emergency vehicle and/or lightbar (such as the stop engine indication.

One skilled in the art should understand that the above examples are not limiting, and the indicator light 110 and/or the warning lights 105A, 105B could operate in a variety of flashing patterns.

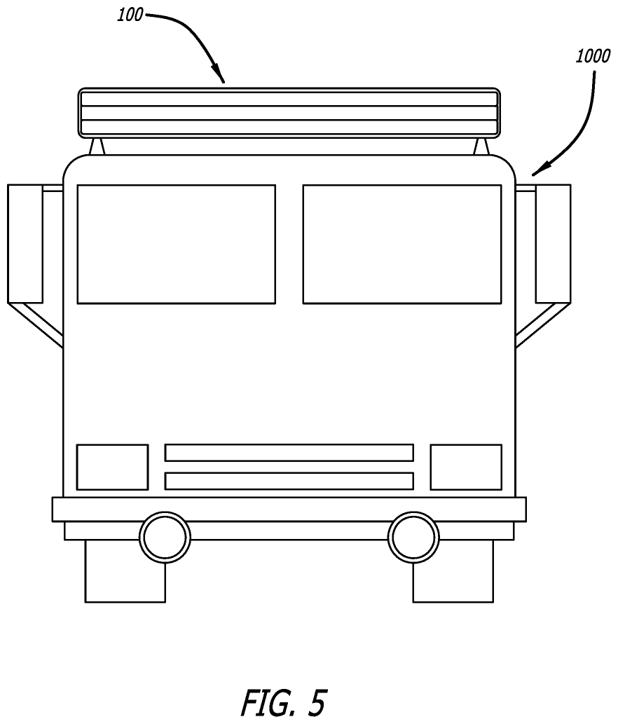

FIG. 5 is an example lightbar 100 coupled with an emergency vehicle 1000, in accordance with the present technology. In some embodiments, the lightbar 100 is configured to be coupled to an emergency vehicle 1000. In some embodiments, the emergency vehicle 1000 is a firetruck, but in other embodiments, the emergency vehicle 100 is an ambulance, police car, police boat, plane, or the like. In some embodiments, the light bar 100 is located on a brow of a front of the emergency vehicle 1000.

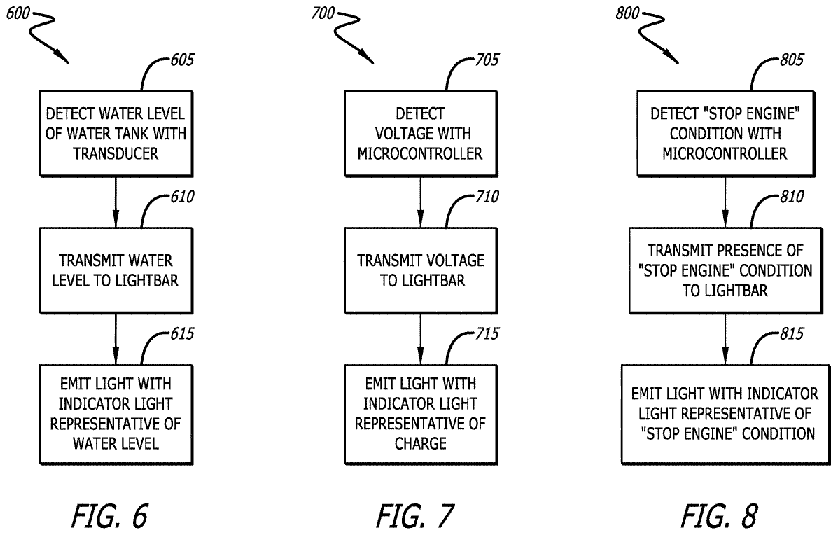

FIG. 6 is an example method 600 of emitting light with an indicator light, in accordance with the present technology. In some embodiments, the method 600 is carried out with a light bar (such as light bar 100) including warning lights (such as warning lights 105A, 105B) and an indicator light (such as indicator light 110). In some embodiments, lightbar may be coupled with a processor (such as processor 220) which may communicate with a plurality of sensors (such as plurality of sensors 245) a stop engine sensor (250), and/or a transducer (such as transducer 240) of a water tank (such as water tank 235).

In block 605, a water level of a water tank is detected with a transducer. In some embodiments, the water tank is located on or inside an emergency vehicle (such as emergency vehicle 1000).

In block 610, the transducer transmits the detected water level to the processor, which then transmits that water level to the light bar.

In block 615, the indicator light of the light bar emits light that represents the water level of the water tank. In some embodiments, this may be done with a visual percentage indication (as shown and described in FIG. 3A), with a solid color (such as red for low, yellow for about half full, and green for full) (as shown in FIG. 3C), or with a flashing pattern (as shown in FIGS. 4A-4D).

FIG. 7 is another example method 700 of emitting light with an indicator light, in accordance with the present technology. In some embodiments, the method 700 is carried out with a light bar (such as light bar 100) including warning lights (such as warning lights 105A, 105B) and an indicator light (such as indicator light 110). In some embodiments, lightbar may be coupled with a processor (such as processor 220) which may communicate with a plurality of sensors (such as plurality of sensors 245) a stop engine sensor (250), and/or a transducer (such as transducer 240) of a water tank (such as water tank 235).

In block 705, a voltage of an emergency vehicle (such as emergency vehicle 1000) is detected, such as with a microcontroller, indicative of a charge level.

In block 710, the microcontroller transmits the charge level to the lightbar.

In block 715, the indicator light of the light bar emits light that represents the charge level of the emergency vehicle. In some embodiments, this may be done with a visual percentage indication (as shown and described in FIG. 3A), multiple color lights in a graduating bar graph (as shown in FIG. 3B), with a solid color (such as red for low, yellow for about half full, and green for full) (as shown in FIG. 3C), or with a flashing pattern (as shown in FIGS. 4A-4D).

FIG. 8 is yet another example method 800 of emitting a light with an indicator light, in accordance with the present technology. In some embodiments, the method 800 is carried out with a light bar (such as light bar 100) including warning lights (such as warning lights 105A, 105B) and an indicator light (such as indicator light 110). In some embodiments, lightbar may be coupled with a processor (such as processor 220) which may communicate with a plurality of sensors (such as plurality of sensors 245) a stop engine sensor (250), and/or a transducer (such as transducer 240) of a water tank (such as water tank 235).

In block 805, a “stop engine” condition of an emergency vehicle (such as emergency vehicle 1000) is detected with the processor/microcontroller of the emergency vehicle. In some embodiments, the “stop engine” condition may also be displayed on a dashboard of the emergency vehicle.

In block 810, the processor transmits the presence of a “stop engine” condition to the lightbar.

In block 815, the indicator light of the light bar emits light that represents the presence of the “stop engine” condition of the emergency vehicle. In some embodiments, this may be done with multiple color lights in a graduating bar graph (as shown in FIG. 3B), with a solid color (such as red for low, yellow for about half full, and green for full) (as shown in FIG. 3C), or with a flashing pattern (as shown in FIGS. 4A-4D).

It should be understood that all methods 600, 700, and 800 should be interpreted as merely representative. In some embodiments, process blocks of all methods 600, 700, 800 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

We claim:

1. A lightbar configured to couple with an emergency vehicle, the lightbar comprising:
one or more warning lights configured to emit an emergency flash pattern; and
an indicator light configured to display one or more status indicators of the emergency vehicle.

2. The lightbar of claim 1, wherein the one or more warning lights are a first warning light and a second warning light.

3. The lightbar of claim 2, wherein the indicator light is disposed between the first warning light and the second warning light.

4. The lightbar of claim 1, wherein the indicator light and the one or more warning lights are combined into a single light source.

5. The lightbar of claim 1, wherein the one or more status indicators of the emergency vehicle include a water level of a water tank of the emergency vehicle, a charge level of the emergency vehicle, a presence of a stop-engine condition of the emergency vehicle, or a combination thereof.

6. The lightbar of claim 1, wherein the indicator light is configured to emit a colored light indicative of the one or more status indicators of the emergency vehicle.

7. The lightbar of any one of claim 1, wherein the indicator light is configured to emit a percentage light indicative of the one or more status indicators of the emergency vehicle.

8. The lightbar of claim 1, wherein the indicator light is configured to emit a flash pattern indicative of the one or more status indicators of the emergency vehicle.

9. The lightbar of claim 1, wherein the indicator light is configured to emit a graduated bar graph of light indicative of the one or more status indicators of the emergency vehicle.

10. The lightbar of claim 1, wherein the one or more warning lights are configured to emit the emergency flash pattern while the indicator light emits displays one or more status indicators of the emergency vehicle.

11. The lightbar of claim 1, wherein the one or more warning lights are configured to stop emitting the emergency flash pattern while the indicator light emits displays one or more status indicators of the emergency vehicle.

12. The lightbar of claim 1, wherein the emergency vehicle is a firetruck.

13. The lightbar of claim 1, wherein the one or more warning lights and the indicator light are controlled independently.

14. The lightbar of claim 13, wherein the one or more warning lights are communicatively coupled to a first circuit, and wherein the indicator light is coupled to a second circuit.

15. A system configured to display a one or more status indicators of an emergency vehicle, comprising:
the lightbar of claim 1;
a plurality of sensors; and
a processor, wherein the processor is configured to:
receive a plurality of signals from the plurality of sensors; and
direct the indicator light of the light bar to display the one or more status indicators of an emergency vehicle based on the plurality of signals.

16. The system of claim 15, wherein the plurality of sensors includes a stop engine sensor and the processor is further configured to:
receive a signal from the stop engine sensor indicative of a presence of a stop engine condition; and
direct the indicator light to emit light indicative of the presence of a stop engine condition.

17. The system of claim 15, wherein the plurality of sensors includes a transducer and the processor is further configured to:
receive a water level signal from the transducer, wherein the water level signal corresponds to a water level of a water tank of the emergency vehicle; and
direct the indicator light to emit light indicative of the water level of the water tank.

18. The system of claim 15, wherein the processor is further configured to:
receive a voltage signal indicative of a charge level of the emergency vehicle; and
direct the indicator light to emit light indicative of the charge level of the emergency vehicle.

19. The system of claim 15, wherein the processor is further configured to:
direct the indicator light to emit light; and
direct the one or more warning lights to emit light, wherein the indicator light and the one or more warning lights are directed to emit light simultaneously.

20. The system of claim 15, wherein the processor is further configured to:
direct the indicator light to emit light; and
turn off the one or more warning lights.

21. The system of claim 15, further comprising a speaker, wherein the speaker is configured to emit an auditory alert in combination with the indicator light.
